(19) United States
(12) Patent Application Publication
(10) Pub. No.: US 2025/0060802 A1
(43) Pub. Date: Feb. 20, 2025

(54) MULTI-DEVICE POWER CONSUMPTION OPTIMIZATION

(71) Applicant: VIRGINIA TECH INTELLECTUAL PROPERTIES, INC., Blacksburg, VA (US)

(72) Inventors: Chinmay Kendurkar, Blacksburg, VA (US); Poorvesh Dongre, Blacksburg, VA (US)

(21) Appl. No.: 18/726,264

(22) PCT Filed: Jan. 6, 2023
(86) PCT No.: PCT/US23/60220

§ 371 Date: Jul. 2, 2024

Related U.S. Application Data
(60) Provisional application No. 63/297,415, filed on Jan. 7, 2022.

(51) Int. Cl. G06F 1/3206; G06F 1/28

(52) U.S. Cl. CPC G06F 1/3206; G06F 1/28

(57) ABSTRACT

Disclosed are embodiments for a multi-device power consumption optimization framework that can conserve total power consumed across a collection of computing devices. In one embodiment, a method can include: obtaining power consumption characteristics data corresponding respectively to each of a plurality of computing devices associated with a user; generating a collective power saving strategy corresponding to the plurality of computing devices based on the power consumption characteristics data, the collective power saving strategy comprising one or more power saving operations that, when implemented, conserve a total amount of power used by the plurality of computing devices; and instructing one or more computing devices of the plurality of computing devices to perform at least one of the one or more power saving operations based on the user approval data.

### CROSS-REFERENCE TO RELATED APPLICATION

This application claims the benefit of and priority to U.S. Provisional Patent Application No. 63/297,415, titled “MULTI-DEVICE POWER CONSUMPTION OPTIMIZATION,” and filed Jan. 7, 2022, the entire contents of which is hereby incorporated by reference herein.

### BACKGROUND

Power consumption, as a concept in electronics (e.g., consumer electronics, Internet-of-Things (IoT)) has been studied comprehensively, but only taking into consideration the operations being performed on a single device. In today's connected world, people carry multiple devices with them, all having unique features and constraints. Additionally, the usage characteristics and patterns are unique to all users, thus making the task of finding a personalized solution to the problem of battery life optimization difficult. Further, the dynamic environment of the user's usage pattern can render a device unresponsive and slow by decreasing the processor speed in some devices, and/or making the user interface (UI) appear slow in others (e.g., aggressive battery saving techniques) or loss of power before the user can recharge the device. Even with significant progress in battery technology in the past few years, the issue of power management remains the biggest frustrations among users, and a major limitation to the sensor suite and operations performed on certain devices such as wearables.

The consumer electronics industry is now looking towards the next generation of devices such as augmented reality (AR) and/or virtual reality (VR) devices. For example, some of the next generation of devices will come in the form of goggles and/or glasses that display information by overlaying information in the user's field of view. Many tech companies are now investing heavily into this space to allow for more seamless interaction between humans and different computing environments. There are various hardware related hurdles in the way such as, for example, processing power, display technologies, and battery management. For the technology to be practical, it should have a battery life of at least 8 hours as one example, to get through typical working hours, while keeping the weight low so as to be comfortable for long duration use. The ratio of battery life to battery size has to be maximized, and there is a direct correlation between the ratio and the commercial success of the product.

### SUMMARY

The present disclosure is directed to dynamically and/or intelligently optimizing power consumption across multiple computing devices associated with a user to conserve a total amount of power used by such computing devices. More specifically, embodiments described herein are directed to a multi-device power consumption optimization framework (e.g., a software architecture) that can be implemented to optimize the battery life of a collection of battery powered devices to best suit the usage profile of the user and therefore provide a better overall user experience. As described herein, the multi-device power consumption optimization framework (referred to herein as a “multi-device PCO framework”) can also improve the efficiency and/or longevity of one or more batteries powering such a collection of battery powered devices.

The multi-device PCO framework of the present disclosure can be implemented according to example embodiments described herein to dynamically and intelligently generate a collective power saving strategy for a plurality of computing devices associated with a user based on power consumption characteristics data obtained from each of the plurality of computing devices. The collective power saving strategy can include one or more power saving operations that, when implemented, can facilitate conservation of a total amount of power used by the plurality of computing devices. The multi-device PCO framework can be further implemented as described in example embodiments herein to instruct one or more computing devices of the plurality of computing devices to perform at least one of the one or more power saving operations based on receipt of approval from the user to implement the collective power saving strategy.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters and/or numerals in the figures is intended to represent the same or analogous features, elements, or operations across different figures. Repeated description of such repeated reference characters and/or numerals is omitted for brevity.

FIG. 1 illustrates a diagram of an example, non-limiting computing environment that can facilitate multi-device power consumption optimization according to at least one embodiment of the present disclosure.

FIG. 2 illustrates a flow diagram of an example, non-limiting computer-implemented method that can be implemented to facilitate multi-device power consumption optimization according to at least one embodiment of the present disclosure.

FIG. 3 illustrates another flow diagram of an example, non-limiting computer-implemented method that can be implemented to facilitate multi-device power consumption optimization according to at least one embodiment of the present disclosure.

FIG. 4 illustrates a diagram of an example, non-limiting computing environment that can facilitate multi-device power consumption optimization according to at least one embodiment of the present disclosure.

FIG. 5 illustrates another flow diagram of an example, non-limiting computer-implemented method that can be implemented to facilitate multi-device power consumption optimization according to at least one embodiment of the present disclosure.

FIG. 6 illustrates a block diagram of an example, non-limiting computing device that can facilitate multi-device power consumption optimization according to at least one embodiment of the present disclosure.

### DETAILED DESCRIPTION

As noted above, embodiments of the present disclosure are directed to a multi-device power consumption optimization framework that can be implemented to dynamically and intelligently optimize the battery life of a collection of battery powered devices associated with a user. The multi-device power consumption optimization framework (hereinafter, “multi-device PCO framework”) of the present disclosure can be customized to best suit the usage profile of the user and provide a better overall user experience. Further, the multi-device PCO framework described herein can improve the efficiency and longevity of one or more batteries powering such a collection of battery powered devices associated with the user. Additionally or alternatively, the multi-device PCO framework of the present disclosure can also be implemented to dynamically and intelligently optimize the power source life of a collection of devices that each use a power source other than a battery such as, for example, a capacitor or a supercapacitor.

Accordingly, embodiments of the multi-device PCO framework described herein can be implemented in association with next generation devices (e.g., augmented reality (AR) devices, virtual reality (VR) devices) and/or other devices described herein (e.g., laptops, smartphones, wearables) to preserve the battery life of a certain, primary device (e.g., a preferred device) and/or the collective battery life of all devices associated with a user. In doing so, such embodiments can thereby provide technical and/or user-experienced advantages and/or benefits. For example, operations that consume a relatively large portion of battery capacity and that would otherwise be performed by a certain, primary device (e.g., a preferred device) can be delegated to one or more other devices to preserve and extend the battery life of a battery coupled to such a primary device. By preserving and extending the battery life of such a battery, embodiments of the multi-device PCO framework disclosed herein can thereby improve the efficiency of the battery, which can provide for extended, effective, and/or accurate operation of the primary device (e.g., the hardware and/or software components thereof), and thus, also improve the user experience.

Additionally or alternatively, by preserving and extending the battery life of a battery coupled to a certain, primary device as described above, the multi-device PCO framework of the present disclosure can further improve the longevity of such a battery. For example, some embodiments of the multi-device PCO framework can reduce the number of charging cycles the battery would otherwise experience, which can increase the total duration of the battery life cycle from commissioning to decommissioning.

Moreover, by preserving the battery life of a battery coupled to a certain, primary device as described herein, the multi-device PCO framework of the present disclosure can further provide a user with improved safety and/or security features. For example, a user can select a smartphone as a primary device amongst a group of devices associated with the user. In this example, by delegating relatively high-power consuming operations to one or more other devices in the group of devices, some embodiments of the multi-device PCO framework can preserve the battery power of the smartphone, which the user may need to use to call for help in the event of an emergency.

The embodiments of the multi-device PCO framework described herein also account for the latest consumer technologies such as, for instance, wireless charging and fast charging, as these technologies will affect charging characteristics of various devices. Further, the multi-device PCO framework of the present disclosure can be implemented as a standalone application and/or as an integrated operating system (OS) feature, thereby providing technical flexibility in the manner of application. Privacy concerns can arise with any form of user data collection, and thus, embodiments of the multi-device PCO framework described herein also mitigate risks associated with such privacy concerns.

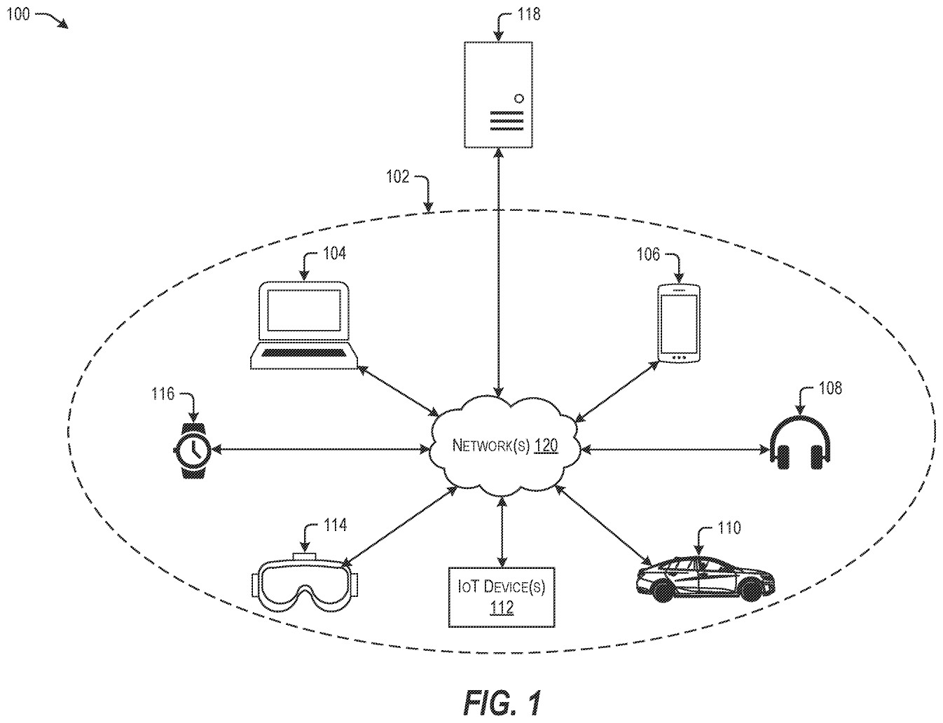

Turning now to the figures, FIG. 1 illustrates a diagram of an example, non-limiting computing environment 100 that can facilitate multi-device power consumption optimization according to at least one embodiment of the present disclosure. In one embodiment, the multi-device PCO framework described herein can be implemented in association with (e.g., using) computing environment 100 and/or one or more computing devices thereof. Computing environment 100 is provided as a representative example, and the concepts of multi-device power consumption optimization described herein can be applied or extended to other computing environments.

Computing environment 100 can include a collection of client computing devices 102 that can be used by or otherwise associated with a user (e.g., ahuman). In the example embodiment depicted in FIG. 1, client computing devices 102 can include, for instance, a laptop 104, a smartphone 106, a smart headset 108, a connected and/or autonomous vehicle 110, one or more Internet of Things (IoT) devices 112 (e.g., smart appliance(s) with or without a wireless power source (e.g., with or without a battery)), an AR and/or VR device 114, a smartwatch and/or smart physiological monitor device 116, and/or another client computing device that can be used by and/or otherwise associated with a user. Client computing devices 102 can be coupled (e.g., communicatively, operatively) to one another and/or to a remote server device 118 (e.g., a server computing device) by way of one or more networks 120.

Although certain client computing devices 102 are depicted in FIG. 1 and described herein for illustrative purposes, it should be appreciated that the present disclosure is not so limiting. For example, client computing devices 102 can include other types of computing devices that can utilize, or not, a wireless and/or portable power source (e.g., a rechargeable or non-rechargeable battery, a capacitor, a supercapacitor) and can be coupled (e.g., communicatively, operatively) to another client computing device 102 by way of network(s) 120.

The network(s) 120 can include any type of communications network. For example, network(s) 120 can include a local area network (LAN), a wide area network (WAN), an intranet, an extranet, and/or the Internet. Further, network(s) 120 can include any number of wired or wireless connections and/or links that can be used to communicate with one or more computing systems and devices such as, for instance, computing environment 100, client computing devices 102, or remote server device 118.

Communication between any devices of computing environment 100 (e.g., client computing devices 102, remote server device 118) can be carried by way of network interface with network(s) 120 using any of a variety of communication protocol(s), encoding(s) or format(s), and/or protection scheme(s). For example, communication between any devices of computing environment 100 can be carried by way of network interface with network(s) 120 using: communication protocols such as, for instance, transmission control protocol/internet protocol (TCP/IP), hypertext transfer protocol (HTTP), simple mail transfer protocol (SMTP), file transfer protocol (FTP), user datagram protocol (UDP), real-time transport protocol (RTP), and/or real-time transport control protocol (RTCP); encodings or formats such as, for instance, hypertext markup language (HTML) and/or extensible markup language (XML); and/or protection schemes such as, for instance, virtual private network (VPN), secure HTTP, secure shell (SSH), secure sockets layer (SSL), and/or secure real-time transport protocol (SRTP).

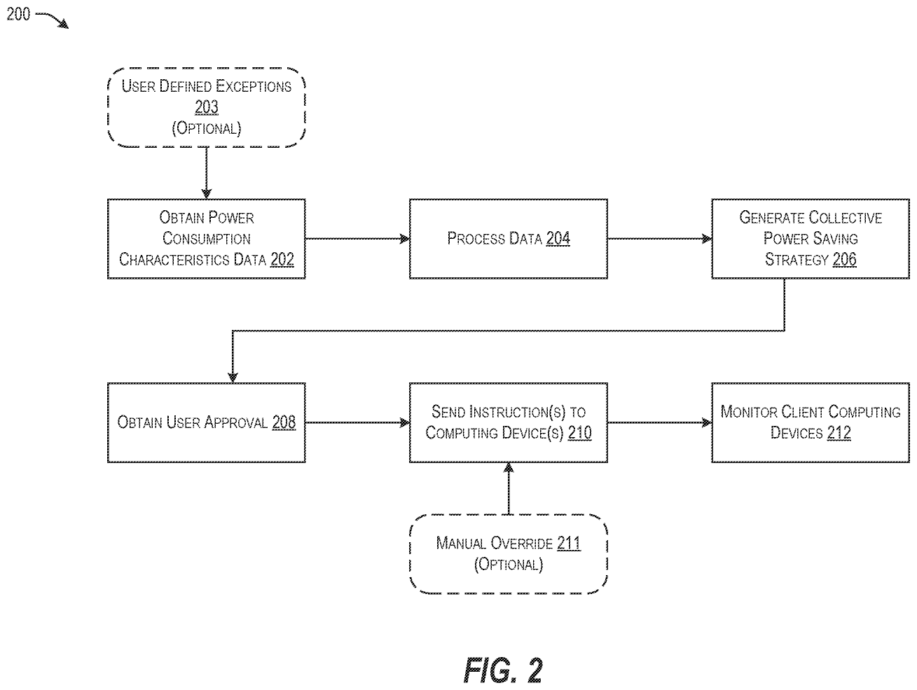

FIG. 2 illustrates a flow diagram of an example, non-limiting computer-implemented method 200 that can be implemented to facilitate multi-device power consumption optimization according to at least one embodiment of the present disclosure. For example, with reference to the example embodiment depicted in FIG. 1, at least one computing device of computing environment 100 can implement computer-implemented method 200 (hereinafter, “method 200”) to facilitate multi-device power consumption optimization across the collection of client computing devices 102.

In one embodiment, any device of client computing devices 102 such as, for example, laptop 104 (e.g., operating as a local server device) can implement method 200 to facilitate multi-device power consumption optimization across the collection of client computing devices 102. In another embodiment, remote server device 118 can implement method 200 to facilitate multi-device power consumption optimization across the collection of client computing devices 102.

For brevity and clarity, example embodiments of the present disclosure are described herein with either laptop 104 or remote server device 118 being the device that can implement various methods disclosed herein (e.g., method 200, 300, 500) to facilitate multi-device power consumption optimization across the collection of client computing devices 102. However, it should be appreciated that the present disclosure is not so limiting. For example, another device of client computing devices 102 that has adequate hardware components, software components, and operating capacity (e.g., processing capacity, memory or storage capacity) can implement any of the methods of the present disclosure (e.g., method 200, 300, 500). For instance, smartphone 106, connected and/or autonomous vehicle 110, IoT device(s) 112, AR and/or VR device 114, or another device of client computing devices 102 can implement method 200, 300, or 500 to facilitate multi-device power consumption optimization across the collection of client computing devices 102.

With reference to FIGS. 1 and 2 collectively, to facilitate multi-device power consumption optimization across the collection of client computing devices 102, at 202 of method 200, laptop 104 or remote server device 118 can obtain (e.g., by way of network(s) 120) power consumption characteristics data corresponding respectively to each client computing device 102. The power consumption characteristics data for each client computing device 102 can include or constitute, for instance: specification data descriptive of one or more hardware components (e.g., processor(s), memory or storage device(s), sensor or data collection device(s), communication device(s)), one or more application modules (e.g., operating system, software component(s)), operational state data descriptive of operational status of such hardware component(s) and/or application module(s), usage data indicative of historical usage, current usage, and anticipated usage by the user associated with client computing devices 102, or a combination thereof.

In one embodiment, at 202 of method 200, laptop 104 or remote server device 118 can obtain the power consumption characteristics data periodically (e.g., every 1 minute, every 5 minutes). In another embodiment, at 202 of method 200, laptop 104 or remote server device 118 can obtain the power consumption characteristics data continuously (e.g., contiguously without interruption, in real-time or near real-time). The laptop 104 or remote server device 118 can also obtain the power consumption characteristics at other schedules, at the request of the laptop 104 at certain timings, or at the request of the client computing devices 102. Additionally, the laptop 104 or remote server device 118 can also obtain the power consumption characteristics from each of the client computing devices 102 at separate, different timings or coordinated timings.

At 203 of method 200, laptop 104 or remote server device 118 can allow for the user to optionally define one or more exceptions to the multi-device power consumption optimization for one or more of the client computing devices 102. For example, the user can define such exception(s) using a user interface that can be generated by laptop 104 and rendered on a display (e.g., monitor, screen) of laptop 104. The user can input data indicative of such exception(s) into such a user interface using one or more input devices of laptop 104 (e.g., keyboard, mouse pad, touchscreen, microphone). In embodiments where laptop 104 implements method 200, laptop 104 can use the user defined exceptions to perform one or more operations of method 200. In embodiments where remote server device 118 implements method 200, laptop 104 can send the user defined exceptions to remote server device 118 by way of network(s) 120 and remote server device 118 can use such exceptions to perform one or more operations of method 200. Laptop 104 can use network(s) 120 to send remote server device 118 any user input received by way of the user interface that can run (e.g., execute) on laptop 104.

The user defined exception(s) can include exception(s) to or otherwise associated with one or more battery saving characteristics (BSC) and/or one or more battery saving characteristic levels (BSCL) of any client computing device 102. As referenced herein, the battery saving characteristic(s) (BSC) of a device can refer to one or more features (e.g., operation features) of the device that affect the power consumption pattern of the device and which can be altered to change the power consumption pattern of the device, for example, based on the user's behavior and/or external characteristics (e.g., temperature). As referenced herein, the battery saving characteristic level(s) (BSCL) of a device can refer to the level(s) of aggressiveness that can be applied to the battery saving characteristic(s) (BSC), for example, to change the power consumption pattern of the device.

Accordingly, at 203 of method 200, the user can optionally define an exception(s) to the multi-device power consumption optimization of one or more of the client computing devices 102, individually, by defining an exception(s) to the BSC and/or BSCL of any client computing device 102. For example, the user can optionally define such exception(s) at a sensor level and/or at a device level. For instance, the user can optionally define exception(s) to: prohibit the collection of sensor data (e.g., global positioning system (GPS) data) by any client computing device 102; prohibit the collection and/or processing of certain data by one or more certain client computing devices 102 and/or the sending of the processed data to one or more other client computing devices 102; and/or control a particular sensor and/or feature of any client computing device 102. As one example, the user can create an exception to ensure the multi-device power consumption optimization of one or more of the client computing devices 102 does not involve the operation and/or control of a certain sensor of a certain client computing device 102.

At 203 of method 200, the user can optionally define an exception(s) to the multi-device power consumption optimization for one or more of the client computing devices 102 by defining a relative priority ranking (e.g., primary, secondary, tertiary) of each computing device of client computing devices 102. For instance, the user can optionally define (e.g., assign) a relative priority ranking for each client computing device 102 such that the multi-device power consumption optimization of client computing devices 102 prioritizes the conservation of any battery coupled (e.g., operatively) to each client computing device 102 based on (e.g., according to) the relative priority ranking of each client computing device 102.

For example, at 203 of method 200, the user can optionally designate or rank one or more certain devices (e.g., laptop 104, smartphone 106) of client computing devices 102 as a “primary” computing device (e.g., a user preferred device) such that the multi-device power consumption optimization of client computing devices 102 prioritizes the conservation of at least one battery coupled (e.g., operatively) to such a primary computing device(s) over the conservation of any battery coupled (e.g., operatively) to any other client computing device 102. For instance, based on such a primary computing device designation(s) or ranking(s), the multi-device power consumption optimization of client computing devices 102 can involve a power saving operation that, when implemented (e.g., by one or more client computing devices 102 or remote server device 118), shifts at least one power consuming operation from the primary computing device(s) to one or more secondary computing devices of client computing devices 102.

In one example, the selection, designation, or ranking of one or more “primary” computing devices from client computing devices 102 can be performed by the user (e.g., via the above-described user interface that can run on laptop 104). In another example, the selection, designation, or ranking of the “primary” computing device(s) can be performed automatically (e.g., without user intervention) according to an example embodiment of the multi-device PCO framework described herein (e.g., via remote sever device 118 or a previously designated “primary” computing device such as, for instance, laptop 104).

The selection, designation, or ranking of one or more “primary” computing devices from client computing devices 102 can be dynamic and can change (e.g., via the user or automatically as described above) according to various circumstances such as, for instance, battery percentage or connectivity. For example, if smartphone 106 is designated as a primary computing device and the battery of smartphone 106 dies, then one or more other client computing devices 102 can become the primary computing device(s).

At 204 of method 200, laptop 104, remote server device 118, or one or more other client computing devices 102, can process the power consumption characteristics data obtained at 202 and any user exception(s) defined at step 203. In processing such data at 204 of method 200, laptop 104 or remote server device 118 can incorporate (e.g., account for) any user defined exceptions that may have been input by the user at 203 as described above. For instance, in processing such data at 204 of method 200, laptop 104 or remote server device 118 can identify and/or assign priority to any device(s) designated as a primary computing device(s) at 203 as described above.

In processing the power consumption characteristics data at 204 of method 200, laptop 104 or remote server device 118 can, for instance, perform one or more operations on such data to prepare it for use as input to any machine learning (ML) and/or artificial intelligence (AI) algorithm that may be implemented by laptop 104 or remote server device 118 to generate a collective power saving strategy at 206 of method 200. For example, at 204 of method 200, laptop 104 or remote server device 118 can modify (e.g., alter formatting), transform (e.g., from characters to tokens or vectors), and/or delete one or more portions of the power consumption characteristics data to prepare it for use as input to any ML and/or AI algorithm that may be implemented at 206 of method 200.

At 206 of method 200, laptop 104 or remote server device 118 can generate a collective power saving strategy for the collection of client computing devices 102 based at least in part on the power consumption characteristics data obtained at 202 and/or any user defined exceptions that may have been input by the user at 203. For example, in one embodiment, laptop 104 or remote server device 118 can generate the collective power saving strategy based at least in part on the above-described optional relative priority ranking of one or more client computing devices 102 that can be defined by the user at 203 as described above.

The collective power saving strategy can include one or more power saving operations that, when implemented by one or more of the client computing devices 102 and/or remote server device 118, conserve of a total amount of power collectively used by client computing devices 102. The collective power saving strategy and/or the power saving operation(s) thereof can be implemented to facilitate the multi-device power consumption optimization of client computing devices 102 as described herein according to example embodiments.

In one example, at 206 of method 200, laptop 104 or remote server device 118 can generate the collective power saving strategy periodically (e.g., every hour), periodically, or according to a predefined schedule. In another case, laptop 104 or remote server device 118 can generate the collective power saving strategy dynamically, such as immediately upon obtaining the power consumption characteristics data at 202 and/or immediately upon obtaining any change to such data at 202 or 203.

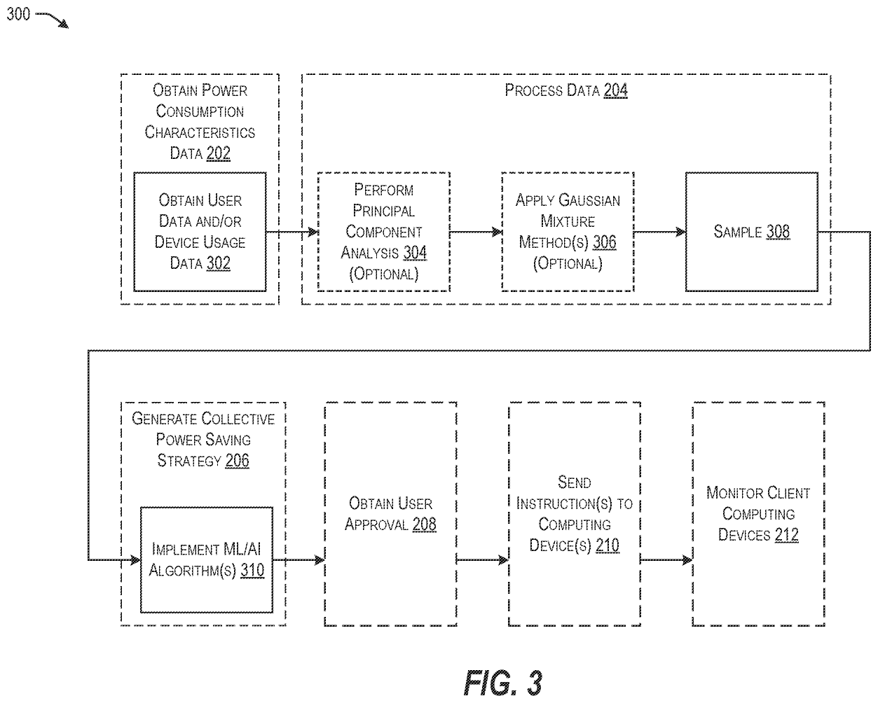

The laptop 104 or remote server device 118 can generate the collective power saving strategy intelligently by using, for example, one or more ML and/or AI algorithms to learn and predict one or more usage or behavior patterns of the user. The ML and/or AI algorithms can facilitate multi-device power consumption optimization of client computing devices 102 based at least in part on such usage and/or behavior pattern(s). For example, as described below with reference to the example embodiment illustrated in FIG. 3, laptop 104 or remote server device 118 can generate the collective power saving strategy intelligently by using, for instance, logistic regression, a support vector machine(s), a decision tree(s), random forest, and/or another ML and/or AI algorithm to learn and/or predict the usage and/or behavior pattern(s) of the user to facilitate multi-device power consumption optimization of client computing devices 102 based at least in part on such usage and/or behavior pattern(s).

At 208 of method 200, laptop 104 or remote server device 118 can obtain approval from the user to implement the collective power saving strategy generated at 206. For example, laptop 104 or remote server device 118 can use the above-described user interface that can be generated and rendered on a display of laptop 104 to present the collective power saving strategy to the user. At 208 of method 200, the user can use such a user interface rendered on laptop 104 to, for example, select (e.g., click, engage) an “APPROVED” button on the user interface to indicate the user's approval of the collective power saving strategy. Additionally, and/or alternatively, the user can optionally use such a user interface to modify any portion of the collective power saving strategy such that it reflects and/or includes any preferences and/or user input that may be provided by the user at 208 by way of the user interface rendered on laptop 104.

At 210 of method 200, laptop 104 or remote server device 118 can use network(s) 120 to send data indicative of an instruction(s) to one or more client computing devices 102 and/or remote server device 118 to perform or implement one or more power saving operations of the collective power saving strategy based at least in part on (e.g., in response to) receipt of approval from the user to implement the collective power saving strategy at 208. As described above, when implemented (e.g., by one or more client computing devices 102 and/or remote server device 118), such power saving operation(s) can facilitate conservation of a total amount of power collectively used by client computing devices 102.

In one example, such power saving operation(s), when implemented, can define (e.g., configure), implement (e.g., execute), and/or alter a power saving characteristic (e.g., a BSC), a power saving characteristic level (e.g., a BSCL), and/or a configuration setting of one or more client computing devices 102. In another example, such instruction(s) or power saving operation(s) can include charging of one or more batteries coupled (e.g., operatively) to one or more client computing devices 102 to optimize the power consumption of such client computing device(s) 102 or the power consumption of one or more other client computing devices 102 (e.g., a “primary” computing device).

At 211 of method 200, laptop 104 or remote server device 118 can allow for the user to optionally override (e.g., manually) any power saving operation of the collective power saving strategy that is to be performed or is being performed by any client computing device 102 and/or remote server device 118. For example, the user can employ the above-described user interface that can run on laptop 104 to optionally input data indicative of the user's intent to cancel any power saving operation of the collective power saving strategy that will be performed at some time in the future or is currently being performed by any client computing devices 102 and/or remote server device 118.

At 211 of method 200, laptop 104 or remote server device 118 can receive (e.g., via the user interface that can execute on laptop 104) user input data indicative of a cancellation of a certain first power saving operation of the collective power saving strategy. In this embodiment, based at least in part on (e.g., in response to) receiving such user input data indicative of such a cancellation of a certain first power saving operation, laptop 104 or remote server device 118 can send data indicative of an instruction(s) to one or more client computing devices 102 and/or remote server device 118 to perform one or more certain second (e.g., other, different) power saving operations of the collective power saving strategy.

At 212 of method 200, laptop 104 or remote server device 118 can monitor (e.g., periodically or continuously via network(s) 120) client computing devices 102 and/or any activity (e.g., usage) associated with any of such devices to detect anything that can affect the multi-device power consumption optimization of client computing devices 102. For example, laptop 104 or remote server device 118 can monitor the above-described power consumption characteristics data of each client computing device 102 to detect, for instance, a certain event, certain data, certain usage, certain activity, certain user behavior, and/or a certain environmental condition or property that can affect the multi-device power consumption optimization of client computing devices 102. Upon making such a detection, laptop 104 or remote server device 118 can, for example modify the collective power saving strategy and/or one or more power saving operations thereof. Further, upon receiving user approval of such modification(s) in the same or similar manner as described above at 208 of method 200, the laptop 104 or remote server device 118 can instruct one or more client computing devices 102 and/or remote server device 118 accordingly based on such modification(s) in the same or similar manner as described above at 210 of method 200.

At 212 of method 200, laptop 104 or remote server device 118 can monitor the operations of the at least one client computing device 102. For example, the laptop 104 or remote server device 118 can detect a defined event (e.g., nearly discharged battery) associated with at least one client computing device 102. In this embodiment, based on or in response to detecting such a defined event, laptop 104 or remote server device 118 can instruct one or more client computing devices 102 and/or remote server device 118 to perform one or more existing and/or modified power saving operations (e.g., shifting relatively high power consuming operations to one or more other client computing devices 102).

At 212 of method 200, laptop 104 or remote server device 118 can also determine that an additional computing device has been added to the client computing devices 102 or an existing computing device of client computing devices 102 has been removed from client computing devices 102. In this embodiment, based on making such a determination, laptop 104 or remote server device 118 can modify the collective power saving strategy and/or one or more power saving operations thereof to account for the addition of the additional computing device to client computing devices 102 or the removal of the existing computing device from client computing devices 102. Additionally or alternatively, based on making such a determination, laptop 104 or remote server device 118 can instruct one or more client computing devices 102 and/or remote server device 118 to perform one or more existing and/or modified power saving operations to account for the addition of the additional computing device to client computing devices 102 or the removal of the existing computing device from client computing devices 102.

FIG. 3 illustrates a flow diagram of an example, non-limiting computer-implemented method 300 that can be implemented to facilitate multi-device power consumption optimization according to at least one embodiment of the present disclosure. Computer-implemented method 300 (hereinafter, “method 300”) can constitute an example, non-limiting alternative embodiment of method 200 described above with reference to FIG. 2. For example, method 300 can constitute an additional, alternative, and/or sub-method of method 200 described above. For instance, as illustrated in FIG. 3, operations of method 300 can be performed as one or more sub-operations of one or more certain operations of method 200 such that the operations of method 300 can be performed simultaneously or concurrently with and/or as a sub-routine of such operation(s) of method 200.

As described above with reference to FIG. 2, in one embodiment, at 206 of method 200, laptop 104 or remote server device 118 can generate the collective power saving strategy intelligently by using, for example, one or more ML and/or AI algorithms to learn and/or predict one or more usage and/or behavior patterns of the user to facilitate multi-device power consumption optimization of client computing devices 102 based at least in part on such usage and/or behavior pattern(s). To generate such a collective power saving strategy intelligently by using ML and/or AI algorithm(s) according to at least one embodiment of the present disclosure, laptop 104 or remote server device 118 can implement method 300 as described below.

At 302 of method 300, laptop 104 or remote server device 118 can obtain user data and/or device usage data, for example, when obtaining the power consumption characteristics data of each client computing device 102 as described above at 202 of method 200. For example, laptop 104 or remote server device 118 can obtain user data and/or device usage data (e.g., historical, current, or anticipated usage data) such as, for instance: user defined input(s) such as the user's calendar data reflecting the user's historical, current, and/or future scheduled events and/or activities; screen-on time; sensor usage; the user's historical and/or current location data (e.g., GPS sensor data or coordinates); device and/or application usage data indicative of which device(s) and/or application(s) the user typically uses, as well as how and/or when the user uses such device(s) and/or application(s); and/or other user data and/or device usage data that can be used to learn and/or predict one or more usage or behavior patterns of the user.

At 304 of method 300, laptop 104 or remote server device 118 can optionally perform principal component analysis (PCA) on the above-described user data and/or device usage data obtained at 302, for example, when processing data at 204 of method 200 (e.g., when processing the data obtained at 202 of method 200). For example, at 304 of method 300, laptop 104 or remote server device 118 can optionally perform principal component analysis (PCA) on the user data and/or device usage data to scale such data as desired. In another example, at 304 of method 300, laptop 104 or remote server device 118 can optionally perform multidimensional scaling (MDS) on the user data and/or device usage data to scale such data as desired.

At 306 of method 300, laptop 104 or remote server device 118 can optionally apply one or more Gaussian mixture methods (GMM) to the above-described user data and/or device usage data obtained at 302, for example, when processing data at 204 of method 200 (e.g., when processing the data obtained at 202 of method 200). For example, at 304 of method 300, laptop 104 or remote server device 118 can optionally apply one or more Gaussian mixture methods (GMM) to the user data and/or device usage data to oversample such data as desired. In another example, at 304 of method 300, laptop 104 or remote server device 118 can optionally apply synthetic minority over-sampling (SMOTE) to the user data and/or device usage data to oversample such data as desired.

At 308 of method 300, laptop 104 or remote server device 118 can sample the above-described user data and/or device usage data obtained at 302, for example, when processing data at 204 of method 200 (e.g., when processing the data obtained at 202 of method 200).

At 310 of method 300, laptop 104 or remote server device 118 can implement one or more ML and/or AI algorithms (e.g., trained ML and/or AI algorithm(s)) using the above-described user data and/or device usage data obtained at 302 and/or the data sampled at 308. For example, at 310 of method 300, laptop 104 or remote server device 118 can implement such ML and/or AI algorithm(s) when generating a collective power saving strategy at 206 of method 200.

In one embodiment, at 310 of method 300, laptop 104 or remote server device 118 can implement one or more ML and/or AI algorithms that have been trained to learn and/or predict the usage and/or behavior pattern(s) of the user based at least in part on (e.g., using) the power consumption characteristics data obtained at 202 of method 200, the above-described user data and/or device usage data obtained at 302 of method 300, and/or the data sampled at 308 of method 300. In this embodiment, at 310 of method 300, laptop 104 or remote server device 118 can generate the collective power saving strategy based at least in part on (e.g., using) a prediction of an anticipated usage and/or an anticipated behavior pattern of the user that can be predicted (e.g., output) by, for instance, a logistic regression algorithm, a support vector machine algorithm, a decision tree algorithm, a random forest algorithm, and/or another ML and/or AI algorithm that, once trained, can predict such an anticipated usage and/or anticipated behavior pattern of the user.

Accordingly, laptop 104 or remote server device 118 can implement method 300 to facilitate intelligent multi-device power consumption optimization of client computing devices 102 based at least in part on (e.g., using) a prediction of the anticipated usage and/or anticipated behavior pattern(s) of the user that can be output by a trained ML and/or AI algorithm as described above. As such, laptop 104 or remote server device 118 can: learn one or more usage and/or user behavior patterns corresponding respectively to each client computing device 102, the usage and/or user behavior pattern(s) being indicative of usage behavior of the user with respect to each client computing device 102; detect at least one of such usage and/or behavior pattern(s) (e.g., detect at least one anticipated usage and/or anticipated behavior pattern(s)); generate a collective power saving strategy based at least in part on (e.g., in response to detecting and using) such usage and/or user behavior pattern(s); obtain user approval of such a collected power saving strategy; and/or instruct one or more client computing devices 102 and/or remote server device 118 to perform one or more power saving operations based at least in part on (e.g., in response to) obtaining such user approval of such a collective power saving strategy.

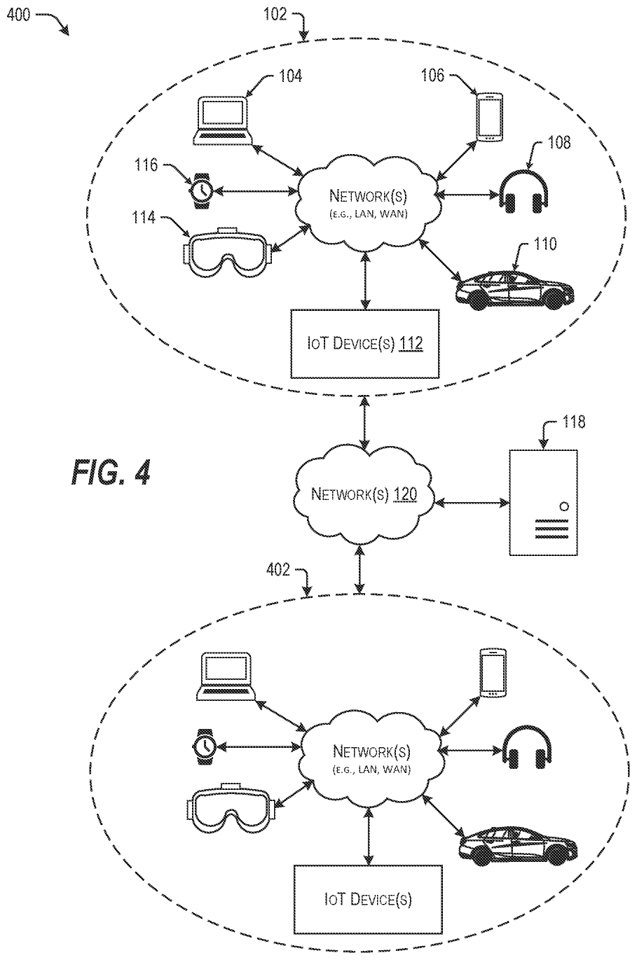

FIG. 4 illustrates a diagram of an example, non-limiting computing environment 400 that can facilitate multi-device power consumption optimization according to at least one embodiment of the present disclosure. Computing environment 400 can constitute an example, non-limiting alternative embodiment of computing environment 100 described above with reference to FIG. 1. A difference between the embodiment depicted in FIG. 1 and the embodiment depicted in FIG. 4 is that computing environment 400 can include an additional collection of client computing devices 402 that can be coupled (e.g., communicatively, operatively) to one another, to the client computing devices 102, and/or to remote server device 118 by way of network(s) 120. In one example, client computing devices 402 can be used by and/or otherwise associated with another, second user that is different from the user that can be associated with client computing devices 102.

Although certain client computing devices 402 are depicted in FIG. 4 and described herein for illustrative purposes, it should be appreciated that the present disclosure is not so limiting. For example, client computing devices 402 can include any type of computing device that can utilize, or not, a wireless and/or portable power source (e.g., a rechargeable or non-rechargeable battery, a capacitor, a supercapacitor) and can be coupled (e.g., communicatively, operatively) to another client computing device 402 by way of network(s) 120.

In one embodiment, one or more client computing devices 402 can include the same attributes, components, and/or functionalities as that of one or more client computing devices 102 (e.g., the client computing device(s) 402 can be the same types of devices as in the client computing device(s) 102). In another embodiment, one or more client computing devices 402 can include attributes, components, and/or functionalities that are different from that of one or more client computing devices 102 (e.g., one or more devices among the client computing device(s) 402 can be different than in the client computing device(s) 102).

In the embodiment depicted in FIG. 4, upon determining that one or more client computing devices 402 are within a certain distance (e.g., 5 feet, 10 feet, 20 feet) from one or more client computing devices 102 to facilitate communication by way of network(s) 120, laptop 104 of client computing devices 102 or remote server device 118 can: obtain (e.g., via network(s) 120) the power consumption characteristics data corresponding respectively to each client computing device 402; generate a second collective power saving strategy for both client computing devices 102 and client computing devices 402 together based on the collective power consumption characteristics data of all such devices, the second collective power saving strategy including and/or constituting one or more second power saving operations that, when implemented (e.g., by one or more client computing devices 102, one or more client computing devices 402, and/or remote server device 118), can facilitate conservation of a second total amount of power used by client computing devices 102 and client computing devices 402; receive second user approval data indicative of a second approval by the user and the second user to implement the second collective power saving strategy; and/or instruct at least one client computing device 102 and/or at least one client computing device 402 to perform at least one of the one or more second power saving operations based on the second user approval data.

In performing the above-described operation(s), laptop 104 of client computing devices 102 or remote server device 118 can generate the above-described second collective power saving strategy based on (e.g., in accordance with), for instance: a second primary computing device that can be selected and designated by the user or the second user from client computing devices 102 or client computing devices 402; and/or a second relative priority ranking of each client computing device 102 and each client computing device 402.

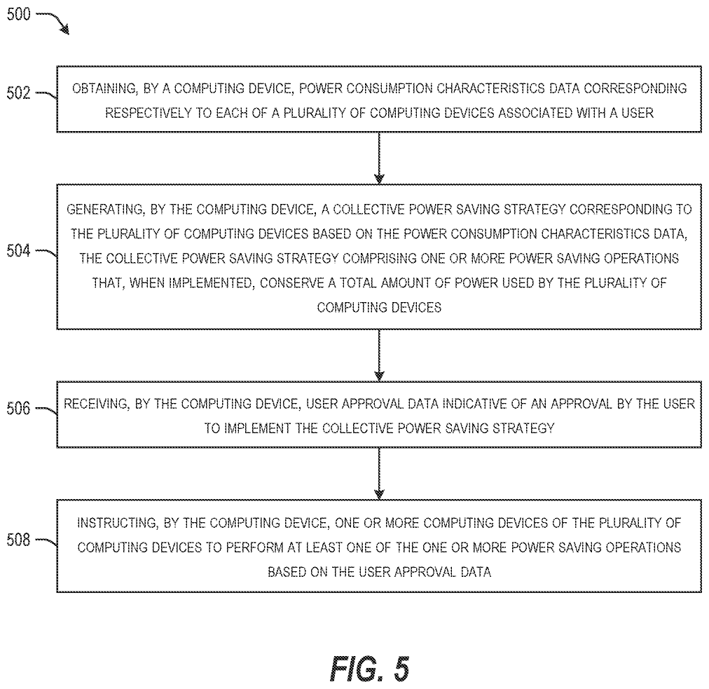

FIG. 5 illustrates a flow diagram of an example, non-limiting computer-implemented method 500 that can be implemented to facilitate multi-device power consumption optimization according to at least one embodiment of the present disclosure. Computer-implemented method 500 (hereinafter, “method 500”) may be implemented using, for instance, any client computing device 102 (e.g., laptop 104) and/or remote server device 118. The example embodiment illustrated in FIG. 5 depicts operations performed in a particular order for purposes of illustration and discussion. Those of ordinary skill in the art, using the disclosures provided herein, will understand that various operations or steps of method 500 or any of the other methods disclosed herein may be adapted, modified, rearranged, performed simultaneously, include operations not illustrated, and/or altered in various ways without deviating from the scope of the present disclosure.

At 502, method 500 can include obtaining, by a computing device (e.g., laptop 104, remote server device 118), power consumption characteristics data (e.g., the specification data, operational state data, usage data, user data, and/or device usage data described above with reference to the embodiments depicted in FIGS. 2 and 3) corresponding respectively to each of a plurality of computing devices (e.g., client computing devices 102) associated with a user.

At 504, method 500 can include generating, by the computing device, a collective power saving strategy corresponding to the plurality of computing devices based on the power consumption characteristics data, the collective power saving strategy comprising one or more power saving operations that, when implemented (e.g., by one or more client computing devices 102 and/or remote server device 118), conserve a total amount of power used by the plurality of computing devices.

At 506, method 500 can include receiving, by the computing device (e.g., via the user interface that can run on laptop 104 as described above with reference to the example embodiment depicted in FIG. 2), user approval data indicative of an approval by the user to implement the collective power saving strategy.

At 508, method 500 can include instructing, by the computing device (e.g., by sending instructions by way of network(s) 120 as described above with reference to the example embodiment depicted in FIG. 2), one or more computing devices (e.g., laptop 104, smartphone 106, smart headset 108, connected and/or autonomous vehicle 110, IoT device(s) 112, AR and/or VR device 114, smartwatch and/or smart physiological monitor device 116) of the plurality of computing devices to perform at least one of the one or more power saving operations based on the user approval data.

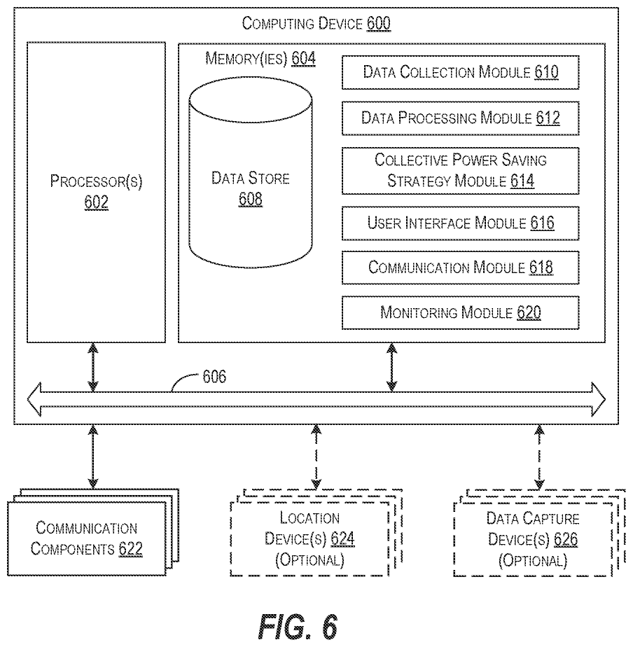

FIG. 6 illustrates a block diagram of an example, non-limiting computing device 600 that can facilitate multi-device power consumption optimization according to at least one embodiment of the present disclosure. In one embodiment, computing device 600 can correspond to, constitute, and/or be included in any client computing device 102, any client computing device 402, and/or remote server device 118. That is, for instance, any client computing device 102, any client computing device 402, and/or remote server device 118 can include the same or similar attributes, components (e.g., hardware, software), and/or functionality as that of computing device 600.

Computing device 600 can include at least one processor circuit, for example, having at least one processor 602 and at least one memory 604, both of which can be coupled (e.g., communicatively, operatively) to a local interface 606. To this end, computing device 600 can constitute and/or include, for example, at least one server computer (e.g., remote server device 118), desktop computer, laptop (e.g., laptop 104), or a like device. Local interface 606 can constitute and/or include, for example, a data bus with an accompanying address/control bus or other bus structure as can be appreciated.

Stored in memory 604 can be both data and one or several components that are executable by processor 602. In particular, stored in memory 604 and executable by processor 602 can be a data collection module 610, a data processing module 612, a collective power saving strategy module 614, a user interface module 616, a communication module 618, a monitoring module 620, and potentially other applications and/or routines (e.g., ML and/or AI routines). Also stored in memory 604 can be a data store 608 and/or other data. In addition, an operating system can be stored in memory 604 and executable by processor 602.

The modules that can be stored in memory 604 (e.g., data collection module 610, data processing module 612, collective power saving strategy module 614, user interface module 616, communication module 618, monitoring module 620) can collectively constitute the multi-device PCO framework described herein that can be implemented in accordance with example embodiments of the present disclosure to facilitate multi-device power consumption optimization of client computing devices 102 and/or client computing devices 402. For example, such modules can be implemented (e.g., run, executed) individually and/or collectively to perform one or more operations of any computer-implemented method of the present disclosure such as, for instance, method 200, 300, and/or 500 described above with reference to the example embodiments depicted in FIGS. 2, 3, and 5, respectively.

Data collection module 610 can be implemented (e.g., run, executed) to obtain the power consumption characteristics data at 202 of method 200 and/or at 502 of method 500. Data collection module 610 can also be implemented to obtain the user data and/or device usage data at 302 of method 300. All of such data (e.g., the power consumption characteristics data, the user data and/or device usage data) can be stored in data store 608 and/or another location in memory 604.

Data processing module 612 can be implemented (e.g., run, executed) to process the power consumption characteristics data at 204 of method 200 and/or at 502 of method 500. Data processing module 612 can also be implemented to process the user data and/or device usage data at 304, 306, and 308 of method 300.

Collective power saving strategy module 614 can be implemented (e.g., run, executed) to generate the collective power saving strategy at 206 of method 200 and/or at 504 of method 500. Collective power saving strategy module 614 can be implemented to intelligently generate the collective power saving strategy at 310 of method 300 using one or more ML and/or AI algorithms (e.g., logistic regression, support vector machine(s), decision tree(s), random forest). Any or all of such ML and/or AI algorithm(s) can be included with collective power saving strategy module 614 and/or stored in data store 608 and/or another location in memory 604.

User interface module 616 can be implemented (e.g., run, executed) to obtain the user's approval of the collective power saving strategy at 208 of method 200 and/or at 506 of method 500.

Communication module 618 can be implemented (e.g., run, executed) to communicate (e.g., using one or more encryption protocols) with other computing devices such as to send instructions to one or more client computing devices 102 and/or remote server device 118 at 210 of method 200 and/or at 508 of method 500.

Monitoring module 618 can be implemented (e.g., run, executed) to monitor client computing devices 102 at 212 of method 200.

Computing device 600 can be coupled (e.g., communicatively, operatively) to one or more communication components 622 (e.g., network interface, transceiver, antenna) that can facilitate communication (e.g., encrypted communication) with any client computing devices 102, any client computing devices 402, and/or remote server device 118.

Computing device 600 can be optionally coupled (e.g., communicatively, operatively) to one or more location devices 624 that can constitute and/or include one or more devices or circuitry for determining the position of computing device 600. For example, such location device(s) 624 can determine an actual and/or relative position of computing device 600 by using a satellite navigation positioning system (e.g., a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or beacons.

Computing device 600 can be optionally coupled (e.g., communicatively, operatively) to one or more data capturing devices 626 that can detect various states (e.g., states associated with computing device 600, a user thereof, and/or a surrounding environment) and can include, for example, a camera(s), a light detection and ranging (LiDAR) device(s), a sonar device(s), radar device(s), an accelerometer(s), a Bluetooth® Low Energy sensor(s), a temperature sensor(s), physiological sensor(s), and/or another data capture device.

It is understood that there may be other applications that are stored in memory 604 and are executable by processor 602 as can be appreciated. Where any component discussed herein is implemented in the form of software, any one of a number of programming languages may be employed such as, for example, C, C++, C#, Objective C, Java©, JavaScript*, Perl, PHP, Visual Basic®, Python*, Ruby, Flash©, or other programming languages.

A number of software components can be stored in memory 604 and are executable by processor 602. In this respect, the term “executable” means a program file that is in a form that can be run by processor 602. Examples of executable programs may be, for example, a compiled program that can be translated into machine code in a format that can be loaded into a random access portion of memory 604 and run by processor 602, source code that may be expressed in proper format such as object code that is capable of being loaded into a random access portion of memory 604 and executed by processor 602, or source code that may be interpreted by another executable program to generate instructions in a random access portion of memory 604 to be executed by processor 602. An executable program may be stored in any portion or component of memory 604 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory 604 is defined herein as including both volatile and nonvolatile memory and data storage components. Volatile components are those that do not retain data values upon loss of power. Nonvolatile components are those that retain data upon a loss of power. Thus, memory 604 can constitute and/or include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, processor 602 can represent multiple processors 602 and/or multiple processor cores and memory 604 can represent multiple memories 604 that operate in parallel processing circuits, respectively. In such a case, local interface 606 can be an appropriate network that facilitates communication between any two of such multiple processors 602, between any processor 602 and any of memories 604, or between any two of memories 604. Local interface 606 can include comprise additional systems designed to coordinate this communication, including, for example, performing load balancing. Processor 602 can be of electrical or of some other available construction.

Although the modules, components, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), and/or other components. Such technologies are well known by those skilled in the art and, consequently, are not described in detail herein.

The flowcharts of FIGS. 2, 3, and 5 each show the functionality and operation of an implementation of portions of the multi-device PCO framework of the present disclosure. If embodied in software, each block illustrated in the flowcharts of FIGS. 2, 3, and 5 may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 602 in a computer system or other system. The machine code may be converted from the source code. If embodied in hardware, each block illustrated in the flowcharts of FIGS. 2, 3, and 5 may represent a circuit or a number of interconnected circuits to implement the specified logical function(s).

Although the flowcharts of FIGS. 2, 3, and 5 each show a specific order of execution, it is understood that the order of execution may differ from that which is depicted. For example, the order of execution of two or more blocks may be scrambled relative to the order shown. Also, two or more blocks shown in succession in the flowcharts of FIGS. 2, 3, and 5 may be executed concurrently or with partial concurrence. Further, in some embodiments, one or more of the blocks shown in the flowcharts of FIGS. 2, 3, and 5 may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present disclosure.

Also, any logic, module, component, or application described herein that constitutes and/or includes software or code can be embodied in any non-transitory computer-readable medium for use by or in connection with an instruction execution system such as, for example, a processor 602 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, universal serial bus (USB) flash drives, or optical discs. Also, the computer-readable medium may be a random-access memory (RAM) including, for example, static random-access memory (SRAM) and dynamic random-access memory (DRAM), or magnetic random-access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic, service, or application described herein may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device such as, for instance, computing device 600, or in multiple computing devices in the same computing environment such as, for example, computing environment 100 and/or 400. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not intended to, and should not, imply that certain embodiments require at least one of X, at least one of Y, or at least one of Z to each be present.

The following includes additional aspects of the multi-device PCO framework of the present disclosure, as well as additional embodiments and/or implementations thereof to further illustrate the various use cases and/or applications of the multi-device PCO framework described herein. Any of the following additional aspects, embodiments, and/or implementations can be facilitated in accordance with the concepts set forth above and/or by using any of the systems (e.g., computing environment 100, 400), devices (e.g., client computing devices 102, client computing devices 402, remote server device 118, computing device 600), networks (e.g., network(s) 120), and/or methods (e.g., method 200, 300, 500) described above with reference to the example embodiments depicted in FIGS. 1, 2, 3, 4, 5, and/or 6.

In connection with computing environment 100 and method 200 described above and illustrated in FIGS. 1 and 2, respectively, one or more “primary” devices can monitor, for example, the battery level, BSC, BSCL, and other power consumption characteristics associated with power consumption optimization of other connected devices (e.g., one or more of client computing devices 102) associated with a user. The choice of primary device can be dynamic and can change according to various circumstances such as battery percentage and connectivity. For example, if the phone battery dies, then a tablet or another smart device can become the primary device. “Dependency values” can be assigned to the devices and wearables in terms of criticality to the user. For example, a smartphone may be designated as a primary device, a tablet as a secondary device, a smartwatch as a primary wearable, smart headphones as a secondary wearable, smart ring as a tertiary wearable, and so on.

In connection with computing environment 100, method 200, and method 300 described above and illustrated in FIGS. 1, 2, and 3, respectively, the devices associated with a user (e.g., one or more of client computing devices 102) can access relevant user data such as the screen-on time, sensor usage, calendar (e.g., schedule), and other information indicative of or relevant to the past and future anticipated (e.g., based on information from the user's calendar) battery usage to build a user behavior profile. The data from devices can be sent to a local server (e.g., a primary device) or to a server for processing. The server may change according to user preference, processing power, battery percentage, etc. Data such as weather, charging speed, temperature, wireless connection (e.g., 5G, 4G, Wi-Fi, BLE) usage duration and characteristics, and the like can also be collected.

In connection with computing environment 100, method 200, and method 300 described above and illustrated in FIGS. 1, 2, and 3, respectively, ML and/or AI algorithm(s) can be used to anticipate events and/or create one or more collective power saving strategies for decreasing power consumption without or minimally hindering use of the user's devices. Example events can include leaving a building or a car (e.g., according to previous uses and calendar information), and thus performing actions in anticipation which predicts the needs of the user and provide relevant solutions while promoting, conserving, or optimizing battery life or decreasing power requirements of the user's devices.

The collective power saving strategy can define BSC and/or BSCL and change in BSC and/or BSCL for each user device depending on triggers (e.g., events, detected states or data), time of day, manual input by the user, and more. The collective power saving strategy can also define the allocation of various operations to devices. In connection with computing environment 100 and method 200 described above and illustrated in FIGS. 1 and 2, respectively, the collective power saving strategy can define various levels of aggressiveness for the BSC or BSCL based on manual input from the user or automatically (e.g., without user intervention) by the above-described processing and dependency ranking of the user devices. The collective power saving strategy or BSCL of various user devices can change dynamically based on relevant data and/or user input. The collective power saving strategy can be used to perform operation(s) and/or change configuration of any user device (e.g., by implementing a battery saver mode). The collective power saving strategy or BSCL can be defined for particular operations (e.g., the collective power saving strategy or BSCL can change according to the device selected for a particular operation). Thus, global and local BSCL can be defined as per the user or automatically.

The user can define exceptions to the collective power saving strategy, BSC, or BSCL at a sensor level or device level (e.g., user can prohibit the collection of GPS sensor data). The user can prohibit collection, processing, and/or sending the processed information sharing to one or more devices. The user can then also allow the exceptions to control a certain sensor feature on one or multiple devices. For example, the user can create exceptions for Bluetooth sensors such that BSC cannot control the sensor.

The collective power saving strategies can be presented to the user for review, modification, and/or approval and taking the user input to select the collective power saving strategy to implement to various devices; or implementing the best and/or most optimal and/or previously user selected collective power saving strategy. The user can manually override the collective power saving strategy, BSC, or BSCL for all devices or selected devices such that the user can select certain BSC and/or BSCL for each or all devices. Periodic review (e.g., monitoring) of the BSC/BSCL for various devices with varied frequency based on external characteristics, usage pattern, user settings, hardware fault, and/or the like.

The collected and/or communicated data can be secured by means of encryption (e.g., hardware and/or software) and facility to store online and/or offline (e.g., on device), and/or anonymizing the data. Onboard device processing can be used for the collected data to gain relevant information with the use of innovations like neural networks (e.g., Neural engine on chips, Tensor chips). Data processing can be performed on high performance devices such as laptops or desktops by creating a local area network (LAN). Data processing can be performed on online servers (e.g., cloud), and hence the use of secure data transfer methods from device to the server. Pre-processing and full or partial data processing can occur on the device through which it was collected (e.g., the data does not leave the device on which it is collected). Such data can be stored in formats and/or ways that avoid the use of the user's personal information such as type of data transfer, amount of data, applications and/or websites used, and/or the like such that the data remains anonymous, secure, and private. For example, the Bluetooth data collected is more about the duration and frequency of use, number of devices connected, and the like. Actual data transferred and/or amount of data are irrelevant to this application, and hence need not be used, collected, and/or stored.

The user can add power banks and/or external power sources which can be taken into consideration while making optimization calculations and/or generating the collective power saving strategy. Additionally or alternatively, AI, ML, Deep Learning, and other algorithms can be used to identify energy usage patterns in various devices.

The type of data collected can be changed with time. For example, if a user's Bluetooth is always off, the data for the Bluetooth sensor(s) might not add much value to the collective power saving strategy, and thus the information about the sensor can be collected less frequently. The frequency of data collected from sensors and/or sub-systems of the user's devices can change as the user's behavior changes (e.g., if the user starts to use Bluetooth more frequently). The device used, method used, and/or time of day for collecting and/or processing the collected data can be optimized such that a use of the user's device's battery is minimized for deploying generating and/or deploying the collective power saving strategy. The primary device is preferably a local server (e.g., a personal computer) or a cloud server which is permanently connected to a power source, or a device which is charging.

Predefined modes can be generated and offered for the user which differ from user's usual usage characteristics (e.g., weekend hike, long drive) which can be enabled by the user or automatically detected via user's calendar and/or schedule. These can be default for all users or can be based on custom calculated strategies which the user can choose to implement. As more and/or better data is available, the predefined modes are modified to better suit the requirements and power consumption of the user.

Dynamically changing the collective power saving strategy, BSC, or BSCL and optimizing based on the number and/or type of other characteristics of the devices being connected and/or removed (e.g., if a device is added, taking that into consideration in the context of overall connected devices). Use of a single, more optimized device to obtain data and/or information from a sensor and sending the data and/or information to other devices via a less battery intensive mode of transfer. For example, if the user's tablet is charging, the GPS of the tablet will turn on and update weather. If requested from the user, the weather information can be sent to other devices via other (e.g., less battery consuming) modes of data transfer like BLE or Wi-Fi. The information can be shown as a separate notification, or inside the relevant applications themselves.

The information collected can be preferentially updated to devices which are in use. The devices which have not been in use for some time (e.g., and which may be in hibernation) might not be immediately updated. The update can take place once the device becomes active and/or comes out of hibernation. The usage characteristics can also include information about usage of an application and/or feature on a particular device of a user (e.g., the user might have an option to see weather data on the smartwatch but might only see the data on the weather app on their smartphone). In such cases, the weather data on a device might not be updated at all, or at a lower frequency as relative to other devices, unless the user actively interacts with the multi-device PCO application on the device (e.g., smartwatch's weather app might update once in 2 hours while weather data on a smartphone is being updated every half hour. If the user opens the weather app and/or widget, the data will update at that time). If an application on a device is not updated, a UI feature can indicate the update status (e.g., up to date, refreshing, not updated, updated X hours ago).

In normal operation, the battery life of independent devices carried by the user is optimized (e.g., if the user is wearing three devices, in which two can independently provide connectivity via internet or calling, the battery is optimized such as to prolong battery life of at least one device during a typical charge and discharge cycle).

The priority and choice of intermittent use of sensors can be according to the user's location, based on the probability of drastic change (e.g., weather at high altitude locations can change more rapidly as compared to a desert). The device(s) in this scenario can be sent a push notification to update the user on a rapidly involving scenario (e.g., in the case of special weather statements and/or significant weather changes are detected. The notification can be sent via the internet based on the user's last location, instead of using the user's GPS sensor).

Systematic holds can be placed on the processor and display, thus reducing the features that the user can access to, while also taking into account user preference and targeting lesser used features and/or sensors to perform optimization. For example, if the user has a preference to run Bluetooth on his device, the device will calculate reductions in other areas, for example weather, display brightness, and proceed accordingly. In this scenario, the weather will not get updated as frequently, and the user might miss notifications due to inhibition of vibrations.

In connection with computing environment 100 and method 200 described above and illustrated in FIGS. 1 and 2, respectively, the user can designate one or more “primary” devices whose optimization can be prioritized (e.g., also referred to as “preferential loading”), and thus choose to use compatible sensors from other devices even if the result is not optimized as a whole (e.g., the user might choose to check weather via a smartwatch's GPS and long-term evolution (LTE) sensors as opposed to their phone's, even if the phone's battery is better optimized for this task).

Manual override of collective power saving strategy: for example, in case of an emergency, all relevant sensors can be turned on to collect vital information by overriding the collective power saving strategy. Recommendation(s) can be presented to the user to perform relevant current and/or future operations on a device more suited (e.g., power efficiency wise) to perform operations, and present an option to make the device default for the action. Take user input for their preferred device for particular operations and change collective power saving strategy for the particular operations so as to make changes to the system that gives maximum power efficiency. The user can change the device being used in between the operations, and thus change the collective power saving strategy for the relevant device(s) automatically.

A device BSCL can be selected according to the device's use (e.g., duration, frequency, time of day) throughout the day. For example, if a smartwatch is used more in the evening, the collective power saving strategy and/or the device BSCL can be more aggressive during the morning and afternoon. The frequency and duration of sensor use can be dynamically controlled according to the collective power saving strategy (e.g., the GPS can be activated every two hours for weather. The frequency might change if bad weather is expected, for example, a tornado watch). If local devices are low on energy, then processing can be offloaded to a cloud computing service. Constant inter-device communication is allowed only when all inter-connected devices have more than a certain battery percentage.

Intelligently and dynamically limit output methods such as vibrations, sound, and the like. Variable smart output strategies according to the user's current environment, past behavior, and/or preferences (e.g., ringing at a volume which is dependent on ambient noise, vibrating only after the user is not responsive to the ringing for more than 10 seconds).

In case of imminent battery failure, relevant and important data can be shifted to any e-ink display that is connected to the user (e.g., transfer of information related to directions if the battery dies during navigation). Devices having multiple batteries can be configured in such a way that the collective power saving strategy is in line with maximizing battery life (e.g., consuming the batteries equally might give a longer battery life and more battery life cycles than consuming one battery after another). One application can be used on different devices in different ways, and this can be accounted for in the collective power saving strategy (e.g., navigational applications are better on a phone while the user is biking but gives sufficient functionality on a smartwatch if the user is walking). The user might be prompted to use the other device, more so if the battery shows warning signs.

Minimum viable operation and/or limp mode: When low battery status is detected by user input, the device(s) can go into this mode to maximize the battery life. It will also work, for example, when the user has a scheduled time of use which does not support normal operations for the entire time period (e.g., use of a single wireless earbud as an extreme measure to maximize battery life).

Devices having multiple displays and/or outputs: The use of a part of a display, speaker, and/or the like can be eliminated and/or optimized according to the mode of aggressiveness selected (e.g., half of the display can be lit up to show notifications, can use less number of pixels on an LED, micro-LED, and/or nano-LED displays to decrease the functioning number of pixels, thus maximizing battery life). Devices having supercapacitors and/or capacitors as the main energy storage medium may use slightly different collective power saving strategies, and for which the queueing operations for when the device is charging would be more effective than battery operated devices.

The BSC related user data can be stored inside the device itself (e.g., user fingerprint and facial recognition data) or another local server. Data can also be stored anonymously on the cloud. The data collected is not the user's private data, but only their overall usage characteristics related to sensors and other hardware on devices.

The collective power saving strategy can maximize battery life cycles. Thus, adopting strategies which balance and/or give priority to battery life or battery life cycles according to user preference, need, and/or usage characteristics (e.g., if the user has a short day, the battery might be charged only to 90% as opposed to 100% since it increases the number of life cycles of the battery). Inter-device communication protocols can be changed based on BSC and/or BSCL and real time battery status of the device(s). The minimum possible and optimum battery percentage for the user can be calculated and/or accounted for in the collective power saving strategy.

In connection with computing environments 100 and 400 described above and illustrated in FIGS. 1 and 4, respectively, a group of people (e.g., a family going on a trip together), all their devices can be linked, temporarily, using the multi-device PCO framework of the present disclosure.

Notifications can be sent only to devices the user is currently interacting with, has just interacted with, and/or having a high probability of interacting with. Only priority notifications should be displayed to other and/or all user devices. In connection with computing environment 100 and method 200 described above and illustrated in FIGS. 1 and 2, respectively, notifications can be prioritized on alternate devices (e.g., one or more of client computing devices 102) as and when possible, if deemed more energy efficient (e.g., haptic feedback on the watch is more noticeable than phone's vibration if it is lying on a table).

Enabling and prioritizing alternate modes of human computer interaction interfaces (UI) based on BSCL (e.g., if a user is wearing earphones and/or headphones, the collective power saving strategy can allow for enabling increased audio interactions since it is more efficient than displays). The user can be warned or notified about unnecessary actions like gaming which might negatively affect future battery life (e.g., playing at night before sleeping is okay, since the phone will charge at night, but playing in the morning will leave less charge for evening and night, particularly if the user has a long schedule). UI can change to signal the battery optimization to the user. The user can be prompted if they try to exit the optimized battery saver mode and/or attempt to cancel and/or override the collective power saving strategy. Suggestions can be presented to users based on schedule and previous use. The user can also be shown the collective power saving strategy, BSC, or BSCL in some part of their device UI (e.g., action center) so as to give more control to the user. The manual input from the user might also be taken into consideration while generating the collective power saving strategy and/or determining future BSCL values (e.g., included as a data input for BSCL).

A minimum possible and/or optimal battery percentage can be recommended to the user if there is some deviation detected and/or user needs to charge the device. If the battery consumption for connecting and uploading is deemed to be more power efficient than doing calculations on a user device, the data can be processed externally in servers. Processing for generating the collective power saving strategy can be done via cloud computing where the data can be stored in an anonymized format.

Buffering and/or downloading of relevant content can be completed before a certain predicted event occurs, for example, if the user is predicted to leave a Wi-Fi network, to minimize the use of mobile data, and hence save time and power. If one or more devices are predicted to be separated (e.g., getting out of a vehicle), then the operations of the collective power saving strategy can be performed in such a way that a central device can perform operations which can be done in a more efficient manner on that device (e.g., location and/or weather data can be updated just before leaving the vehicle). The data can then be sent to any or all relevant devices connected to the user via an efficient manner (e.g., BLE, Wi-Fi). The collective power saving strategy, BSC, or BSCL can be changed and/or manually selected by using varied predefined triggers (e.g., shortcuts), which may be user defined.

In connection with computing environment 100 and method 200 described above and illustrated in FIGS. 1 and 2, respectively, the use of external battery sources coupled to one or more client computing devices 102 can be controlled according to the collective power saving strategy such as, for instance, turning on/off, changing charging rate, and/or the like (e.g., if a charging device such as an external battery pack is connected to one or multiple devices, the collective power saving strategy can allow for enabling and/or disabling the charging to maximize power efficiency, and prioritize one device over another). Recommendations can be presented to the user about their charging characteristics as a way to maximize long term health of the battery as well as short term battery life.

Any operation such as, for instance, data collection, processing, monitoring, and/or another operation can take place on a preferred device according to its current battery and charging status (e.g., if a smartwatch is being charged, the processing and data collection can be moved to that device, even if the computation power is lower). The data can be transferred to other devices with the use of low energy connectivity options such as, for example, Wi-Fi and/or BLE (e.g., while charging, a smartwatch can update its weather using a GPS sensor. The weather application in other devices can also be updated on other devices using BLE).

Certain processes (e.g., tasks with high processor power requirement) can be paused until set conditions for charging and/or battery conditions are met, with an exception for user input, which can be implicit or explicit. For instance, processes such as video and/or image processing can be paused until the device is plugged in, unless the user decides to share the file (e.g., implicit user input), in which case, the processing takes place by overriding the pause. The user can be notified, asked for, and/or recommended to pause the processes, and if the user gives explicit input for the above processes, the process can be done by overriding the pause.

Updates and notifications can be given on the device which is currently in the charging process, if the user has recently interacted with the device. The same notifications can be delayed/posted as “silent notifications” on other devices. If the notification is deemed as “urgent” or “high priority,” then other devices can also be notified for the same. The user device with the better charging rate can be used for energy intensive operations (e.g., if a smartwatch has a faster charging rate than the phone, operations can be performed on the smartwatch). The user device which is the nearest to a full charge, based on the device's charging use characteristics can be used for such energy intensive operations. Charging profile can be configured according to the number and intensity of operations, that is, charging rate can be dependent on the operations (e.g., the charging rate can be increased if it is detected that a greater number of operations (e.g., updating weather, other information) have to be performed on that device). Thus, the charging profile of devices can be configured according to the same information.

Scheduling tasks to devices which are currently charging, even if computational efficiency and/or speed is lower on the devices. For example, obtaining weather data might be faster in a smartphone, but can be done on a smartwatch if it is charging (e.g., based on the battery percentage and urgency of the operation). The user can be notified of better charging options for their connected devices which are best suited for their schedule. For instance, if charging their smartwatch for 15 mins will increase the device's battery life, the user can be advised to do the same. The user can be notified of nearby charging options available (e.g., location-based data).

If a wearable and/or other device does not support the hardware that can function at this level, the device it is connecting to (e.g., a smartphone) can force the hardware device to optimize (e.g., when the device tries to connect with Bluetooth to a phone, the phone will intentionally not connect, thus forcing the device to go into a ‘hibernation’ mode until user movement and/or input is detected). If a user is privacy conscious, they can be given an option to manually input their preferences regarding the use of their devices (e.g., time of day, sensors), which can be displayed as a “survey form” to gain basic information about usage characteristics and apply for BSCL.

It should be emphasized that the above-described embodiments of the present disclosure are merely possible examples of implementations set forth for a clear understanding of the principles of the disclosure. Many variations and modifications may be made to the above-described embodiment(s) without departing from the spirit and principles of the disclosure. All such modifications and variations are intended to be included herein within the scope of this disclosure and protected by the following claims.

Therefore, at least the following is claimed:

1. A method to provide multi-device power consumption optimization, comprising:
obtaining, by a computing device, power consumption characteristics data corresponding respectively to each of a plurality of computing devices associated with a user;
generating, by the computing device, a collective power saving strategy corresponding to the plurality of computing devices based on the power consumption characteristics data, the collective power saving strategy comprising one or more power saving operations that, when implemented, conserve a total amount of power used by the plurality of computing devices; and
instructing, by the computing device, one or more computing devices of the plurality of computing devices to perform at least one of the one or more power saving operations.

2. The method to provide multi-device power consumption optimization of claim 1, wherein the power consumption characteristics data comprises at least one of: specification data descriptive of at least one of one or more hardware components or one or more application modules; operational state data descriptive of operational status of at least one of the one or more hardware components or the one or more application modules; or usage data indicative of at least one of historical usage, current usage, or anticipated usage.

3. The method to provide multi-device power consumption optimization of claim 1, further comprising:
receiving, by the computing device, user input data indicative of a relative priority ranking of each computing device of the plurality of computing devices; and
generating, by the computing device, the collective power saving strategy based at least in part on the relative priority ranking.

4. The method to provide multi-device power consumption optimization of claim 1, wherein the plurality of computing devices comprises the computing device, wherein the computing device is designated as a primary computing device of the plurality of computing devices, and wherein the one or more power saving operations, when implemented, shift at least one power consuming operation from the computing device to one or more secondary computing devices of the plurality of computing devices.

5. The method to provide multi-device power consumption optimization of claim 1, further comprising:
receiving, by the computing device, user input data indicative of a cancellation of a first power saving operation of the one or more power saving operations; and
instructing, by the computing device, the one or more computing devices to perform a second power saving operation of the one or more power saving operations based at least in part on the cancellation.

6. The method to provide multi-device power consumption optimization of claim 1, wherein the one or more power saving operations, when implemented, alter at least one of a power saving characteristic, a power saving characteristic level, or a configuration setting corresponding respectively to at least one computing device of the plurality of computing devices.

7. The method to provide multi-device power consumption optimization of claim 1, further comprising:
monitoring, by the computing device, the power consumption characteristics data corresponding respectively to each of the plurality of computing devices;
detecting, by the computing device, a defined event associated with at least one computing device of the plurality of computing devices; and
instructing, by the computing device, the one or more computing devices to perform at least one of the one or more power saving operations based on detection of the defined event.

8. The method to provide multi-device power consumption optimization of claim 1, further comprising:
learning, by the computing device, one or more usage patterns corresponding respectively to each of the plurality of computing devices, the one or more usage patterns being indicative of usage behavior of the user with respect to each of the plurality of computing devices;
predicting, by the computing device, at least one of the one or more usage patterns; and
instructing, by the computing device, the one or more computing devices to perform at least one of the one or more power saving operations based on prediction of at least one of the one or more usage patterns.

9. The method to provide multi-device power consumption optimization of claim 1, further comprising:
determining, by the computing device, that at least one of an additional computing device has been added to the plurality of computing devices or an existing computing device of the plurality of computing devices has been removed from the plurality of computing devices; and
modifying, by the computing device, at least one of the collective power saving strategy or the one or more power saving operations based on at least one of addition of the additional computing device to the plurality of computing devices or removal of the existing computing device from the plurality of computing devices.

10. The method to provide multi-device power consumption optimization of claim 1, further comprising:
obtaining, by the computing device, second power consumption characteristics data corresponding respectively to each of a second plurality of computing devices associated with a second user;
generating, by the computing device, a second collective power saving strategy corresponding to the plurality of computing devices and the second plurality of computing devices based on the power consumption characteristics data and the second power consumption characteristics data, the second collective power saving strategy comprising one or more second power saving operations that, when implemented, conserve a second total amount of power used by the plurality of computing devices and the second plurality of computing devices;
receiving, by the computing device, second user approval data indicative of a second approval by the user and the second user to implement the second collective power saving strategy; and
instructing, by the computing device, at least one of the one or more computing devices or one or more second computing devices of the second plurality of computing devices to perform at least one of the one or more second power saving operations based on the second user approval data.

11. A computing device, comprising:
a memory device to store computer-readable instructions thereon; and
at least one processing device configured through execution of the computer-readable instructions to:
obtain power consumption characteristics data corresponding respectively to each of a plurality of computing devices associated with a user;
generate a collective power saving strategy corresponding to the plurality of computing devices based on the power consumption characteristics data, the collective power saving strategy comprising one or more power saving operations that, when implemented, conserve a total amount of power used by the plurality of computing devices; and
instruct one or more computing devices of the plurality of computing devices to perform at least one of the one or more power saving operations.

12. The computing device of claim 11, wherein the at least one processing device is further configured to:
receive user input data indicative of a relative priority ranking of each computing device of the plurality of computing devices; and
generate the collective power saving strategy based at least in part on the relative priority ranking.

13. The computing device of claim 11, wherein the plurality of computing devices comprises the computing device, wherein the computing device is designated as a primary computing device of the plurality of computing devices, and wherein the one or more power saving operations, when implemented, shift at least one power consuming operation from the computing device to one or more secondary computing devices of the plurality of computing devices.

14. The computing device of claim 11, wherein the at least one processing device is further configured to:
monitor the power consumption characteristics data corresponding respectively to each of the plurality of computing devices;
detect a defined event associated with at least one computing device of the plurality of computing devices; and
instruct the one or more computing devices to perform at least one of the one or more power saving operations based on detection of the defined event.

15. The computing device of claim 11, wherein the at least one processing device is further configured to:
learn one or more usage patterns corresponding respectively to each of the plurality of computing devices, the one or more usage patterns being indicative of usage behavior of the user with respect to each of the plurality of computing devices;
predict at least one of the one or more usage patterns; and
instruct the one or more computing devices to perform at least one of the one or more power saving operations based on prediction of at least one of the one or more usage patterns.

16. The computing device of claim 11, wherein the at least one processing device is further configured to:
determine that at least one of an additional computing device has been added to the plurality of computing devices or an existing computing device of the plurality of computing devices has been removed from the plurality of computing devices; and
modify at least one of the collective power saving strategy or the one or more power saving operations based on at least one of addition of the additional computing device to the plurality of computing devices or removal of the existing computing device from the plurality of computing devices.

17. The computing device of claim 11, wherein the at least one processing device is further configured to:
obtain second power consumption characteristics data corresponding respectively to each of a second plurality of computing devices associated with a second user;
generate a second collective power saving strategy corresponding to the plurality of computing devices and the second plurality of computing devices based on the power consumption characteristics data and the second power consumption characteristics data, the second collective power saving strategy comprising one or more second power saving operations that, when implemented, conserve a second total amount of power used by the plurality of computing devices and the second plurality of computing devices;
receive second user approval data indicative of a second approval by the user and the second user to implement the second collective power saving strategy; and
instruct at least one of the one or more computing devices or one or more second computing devices of the second plurality of computing devices to perform at least one of the one or more second power saving operations based on the second user approval data.

18. A non-transitory computer-readable medium embodying at least one program that, when executed by at least one computing device, directs the at least one computing device to:
obtain power consumption characteristics data corresponding respectively to each of a plurality of computing devices associated with a user;
generate a collective power saving strategy corresponding to the plurality of computing devices based on the power consumption characteristics data, the collective power saving strategy comprising one or more power saving operations that, when implemented, conserve a total amount of power used by the plurality of computing devices; and
instruct one or more computing devices of the plurality of computing devices to perform at least one of the one or more power saving operations.

19. The non-transitory computer-readable medium according to claim 18, wherein the at least one computing device is further directed to:
receive user input data indicative of a relative priority ranking of each computing device of the plurality of computing devices; and
generate the collective power saving strategy based at least in part on the relative priority ranking.

20. The non-transitory computer-readable medium according to claim 18, wherein the at least one computing device is further directed to:
monitor the power consumption characteristics data corresponding respectively to each of the plurality of computing devices;
detect a defined event associated with a computing device of the plurality of computing devices; and
instruct the one or more computing devices to perform at least one of the one or more power saving operations based on detection of the defined event.
